(19) United States
(12) Patent Application Publication
(10) Pub. No.: US 2020/0210994 A1
(43) Pub. Date: Jul. 2, 2020

(54) INTELLIGENT PAYMENT CARD CARRYING SYSTEMS AND METHODS

(71) Applicant: Mastercard International Incorporated, Purchase, NY (US)

(72) Inventors: Tara L. Sauer, O'Fallon, MO (US); Marthom Daetz, O'Fallon, MO (US)

(73) Assignee: Mastercard International Incorporated, Purchase, NY (US)

(21) Appl. No.: 16/238,381

(22) Filed: Jan. 2, 2019

(51) Int. Cl. G06Q 20/34; G06Q 20/32

(52) U.S. Cl. CPC G06Q 20/353; G06Q 20/3278; G06Q 20/341

(57) ABSTRACT

An intelligent payment card carrying system for monitoring the presence of a payment card includes a cardholder computing device and a payment card receptacle for receiving the payment card. The cardholder computing device includes a first transceiver for communicating with the payment card receptacle. The payment card receptacle includes a controller having a wireless communication device and a second transceiver. The second transceiver includes NFC-enabled circuitry. The controller communicates wirelessly with the cardholder computing device via the wireless communication device, and with the payment card via the second transceiver to transfer payment card data.

### FIELD OF THE DISCLOSURE

The field of the disclosure relates generally to payment card carrying systems and methods and, more particularly, to systems and methods for monitoring the presence of a payment card and alerting a cardholder when the payment card is no longer present.

### BACKGROUND

A typical consumer may have several payment cards for performing payment card transactions, including for example, a debit card and one or more credit cards. When carrying several payments cards, it can be difficult to keep track of each payment card. For example, when performing a transaction at a merchant, the consumer may remove one of several payment cards for use. The consumer may be distracted for various reasons and may forget or leave the payment card behind. If the consumer glances into their wallet, purse, or other payment card carrying device, she may not immediately be aware that the payment card used for the transaction is missing.

In addition, in some instances, a consumer may place her wallet, purse, etc. down for a brief period. A fraudster may surreptitiously remove one or more payment cards from the consumer's wallet, purse, etc., in such a manner that the consumer may not notice that her payment card is missing for an extending period.

### BRIEF DESCRIPTION

This summary is not intended to identify essential features of the present invention and is not intended to be used to limit the scope of the claims. These and other aspects of the present invention are described below in greater detail.

In one aspect, an intelligent payment card carrying system is provided. The intelligent payment card carrying system facilitates monitoring the presence of a payment card that includes a microchip. The system includes a cardholder computing device having a first transceiver, and a payment card receptacle for receiving the payment card therein. The payment card receptacle includes a controller having a wireless communication device and a second transceiver comprising NFC-enabled circuitry. The controller is configured to communicate wirelessly with the cardholder computing device via the wireless communication device, and with the payment card via the second transceiver to transfer payment card data.

In another aspect, a method for detecting and monitoring the presence of a payment card in a payment card receptacle is provided. The method includes receiving the payment card in the payment card receptacle and communicatively coupling to the payment card to read the payment card data therefrom. The method also includes determining whether the payment card is a registered payment card with the payment card receptacle. If the payment card is a registered payment card, the method includes generating a first notification indicating that the payment card receptacle has successfully communicatively coupled to the registered payment card. Moreover, the method includes detecting that the payment card is no longer communicatively coupled to the payment card receptacle and generating a second notification indicating that the payment card is no longer connected to the payment card receptacle.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a simplified block diagram of an exemplary intelligent payment card carrying system including a portable payment card receptacle in accordance with one embodiment of the present disclosure;

FIG. 2 is a schematic view of a controller contained in the portable payment card receptacle shown in FIG. 1;

FIG. 3 is a block diagram illustrating an example of a user computing system, such as a cardholder mobile computing device shown in FIG. 1;

FIG. 4 is a schematic view of an alternative controller that may be used in the portable payment card receptacle shown in FIG. 1;

FIG. 5 is a flowchart illustrating an exemplary computer-implemented method for registering one or more payment cards shown in FIG. 1 for use with the portable payment card receptacle shown in FIG. 1; and

FIGS. 6A and 6B illustrate a flowchart depicting an exemplary computer-implemented method for detecting and monitoring a payment card stored in the portable payment card receptacle shown in FIG. 1.

The figures depict exemplary embodiments for purposes of illustration only. The figures are not intended to limit the present invention to the specific embodiments they depict. One skilled in the art will readily recognize from the following discussion that alternative embodiments of the systems and methods illustrated herein may be employed without departing from the principles of the invention described herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled. It is contemplated that the disclosure has general application to providing payment card presence detection and monitoring in industrial, commercial, and residential applications.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present disclosure can include a variety of combinations and/or integrations of the embodiments described herein.

Broadly characterized, the present disclosure relates to an intelligent payment card carrying system that monitors the presence of one or more registered payment cards. A payment card carrying device or receptacle, such as a wallet, purse, etc., includes an electronic controller that reads a microchip on the payment card. The controller may read the payment card microchip by making physical electrical connection with the microchip or via a wireless communications link (e.g., NFC, RFID, etc.). In addition, the controller communicates via a wireless connection to a cardholder mobile computing device to facilitate registering the payment card(s) with the system and/or providing alerts/notifications when the payment card is removed or otherwise no longer contained in the payment card carrying device. If the payment card is not returned to the payment card carrying device, the controller may transmit a signal to the payment card issuer to lock the payment card against further use. Thus, the systems and methods facilitate reducing payment card fraud, theft, as well as the risk of distracted cardholders leaving a payment card behind or otherwise losing the payment card.

The methods and systems described herein may be implemented using computer programming or engineering techniques including computer software, firmware, hardware, or any combination or subset therefor. At least one of the technical problems addressed by this system includes: (i) lack of electronic presence detection of payment cards; (ii) increased risk associated for a cardholder in providing a physical payment card to a merchant; and (iii) increased risk of carrying a physical payment card with the cardholder, where the physical payment card may be stolen.

A technical effect of the systems and methods described herein is achieved by performing at least one of the following operations: (i) receiving the payment card in the payment card receptacle; (ii) communicatively coupling to the payment card to read the payment card data therefrom; (iii) determining whether the payment card is a registered payment card with the payment card receptacle; (iv) if the payment card is a registered payment card, generating a first notification indicating that the payment card receptacle has successfully communicatively coupled to the registered payment card; (v) detecting that the payment card is no longer communicatively coupled to the payment card receptacle; and (vi) generating a second notification indicating that the payment card is no longer connected to the payment card receptacle.

The resulting technical effect achieved by the systems and methods described herein is at least one of: (i) detecting the presence of a payment card contained in the payment card receptacle; (ii) monitoring the continued presence of the payment card to facilitate against unauthorized removal of the payment card; (iii) alerting a cardholder of removal of the payment card from the payment card receptacle; (iv) alerting a cardholder that the payment card has not been returned to the payment card receptacle when the cardholder is leaving a location after removing the payment card; and (v) reducing the risk of payment card theft.

### Exemplary System

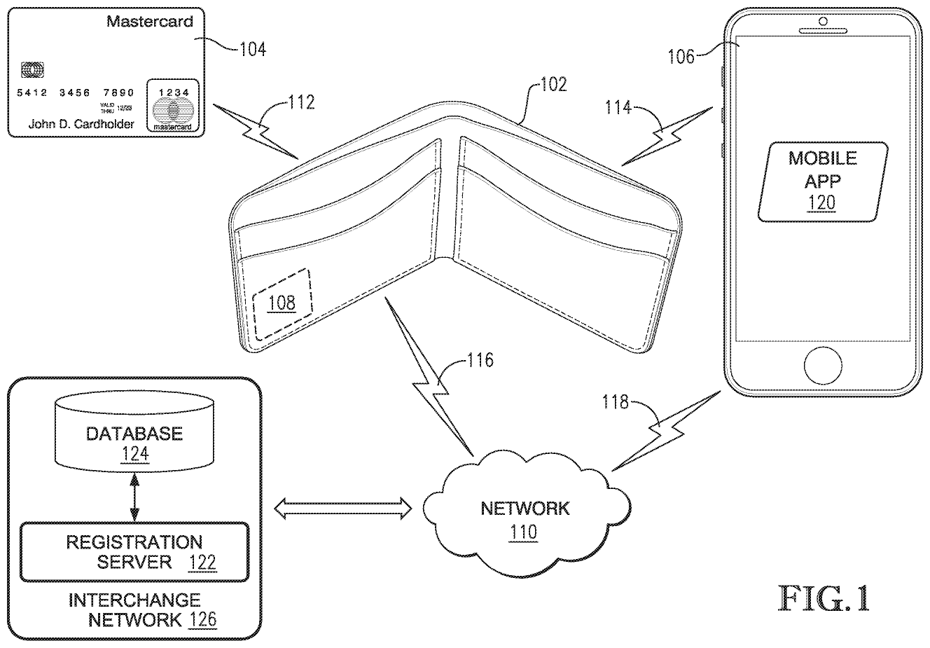

FIG. 1 is a simplified block diagram of an exemplary intelligent payment card carrying system 100 including a portable payment card receptacle 102 in accordance with one embodiment of the present disclosure. The intelligent payment card carrying system 100 may be utilized by cardholders (not shown in FIG. 1) as part of a process of carrying, tracking, and/or locking one or more payments cards 104 when not in use for performing a transaction as described herein. In addition, the intelligent payment card carrying system 100 includes a cardholder mobile computing device 106, which a cardholder may optionally use to lock and/or unlock the payment cards 104 and/or receive notifications concerning the location of the payment cards 104.

In the exemplary embodiment, the portable payment card receptacle 102 is illustrated and described herein as a wallet. However, it is noted that the portable payment card receptacle 102 may be any portable receptacle for carrying and/or storing a payment card when not in use. For example, the portable payment card receptacle 102 may include, without limitation, a credit card holder, a purse, a pouch, a money clip, a passport holder, an attaché case, a briefcase, and the like. Most preferably, the receptacle is any holder or container in which the payment card(s) are stored and transported when not in use.

As illustrated in FIG. 1, the portable payment card receptacle 102 includes a controller 108 configured to communicate with the payment card 104, the cardholder mobile computing device 106, and a communications network 110, via wireless connections 112, 114, and 116, respectively. The cardholder mobile computing device 106 is also configured to communicate with communications network 110 via a wireless signal 118. The communications network 110 includes, for example and without limitation, one or more of a local area network (LAN), a wide area network (WAN) (e.g., the Internet, etc.), a mobile network, a virtual network, and/or any other suitable public and/or private network capable of facilitating communication between the cardholder mobile computing device 106 and the portable payment card receptacle 102. In some embodiments, the communications network 110 may include more than one type of network, such as a private payment transaction network provided by an interchange network (not shown) to merchant acquirers (not shown) and payment card issuers (not shown) and, separately, the public Internet, which may facilitate communication between the portable payment card receptacle 102 and one or more cardholder mobile computing devices 106.

The intelligent payment card carrying system 100 also includes a registration server 122. The registration server 122 includes at least one processor (not shown) in communication with a database 124. The database 124 contains information on a variety of matters, including, for example, one or more stored user profiles, payment card data for the one or more payment cards 104, and other information described herein. In one embodiment, the database 124 is stored on the registration server 122. In an alternative embodiment, the database 124 is stored remotely from the registration server 122 and may be non-centralized. In the example embodiment, the registration server 122 is integral to and/or associated with a payment or interchange network 126.

In the example embodiment, the registration server 122 receives payment card data for the one or more payment cards 104 from the cardholder via one or more of the portable payment card receptacle 102 and/or the cardholder mobile computing device 106. The payment card data relates to the cardholder's payment cards 104 that are to be stored in the portable payment card receptacle 102. The payment card data is stored by the registration server 122 in the database 124.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated.

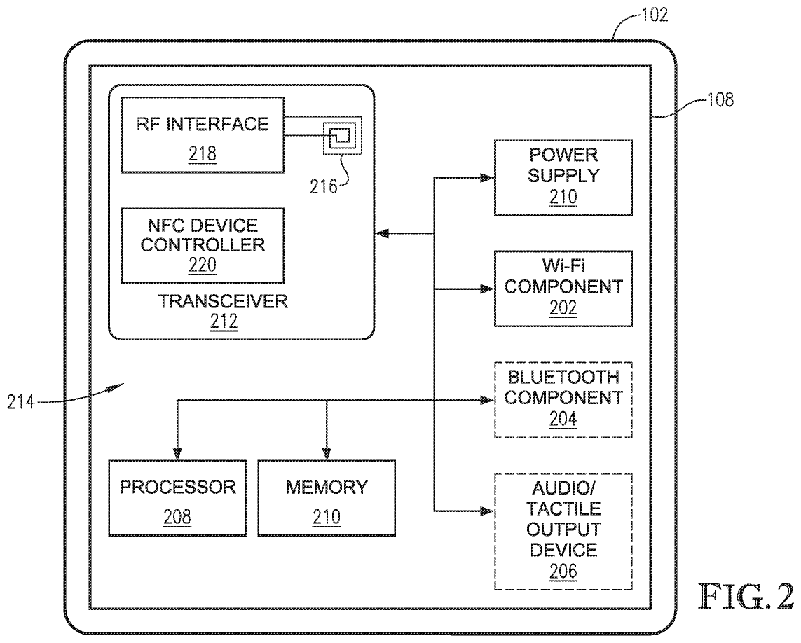

FIG. 2 is a schematic view of the controller 108 contained in the portable payment card receptacle 102. In the example embodiment, the controller 108 is a small form factor computing device configured to wirelessly communicate with a plurality of devices using various wireless technologies.

In the example embodiment, the controller 108 generally includes an integrated Wi-Fi component 202 (e.g., implementing the Institute of Electrical and Electronics/IEEE 802.11 family of standards), an optional Bluetooth component 204 (e.g., implementing capabilities in accordance to the Bluetooth Alliance standards, including Bluetooth classic and Bluetooth Low Energy (BLE)) (broadly, wireless communication devices), and an optional audio/tactile output device 206. In addition, the controller 108 includes a processor 208, a memory device 210, and a transceiver 212 (broadly, a wireless communication device). Moreover, the controller 108 includes an internal power supply 210 (e.g., a battery or other self-contained power source) for providing power to the various electronic components.

The processor 208 includes one or more processing units (e.g., in a multi-core configuration) for executing computer readable instructions. The instructions may be executed within a variety of different operating systems (OS) on the controller 108, such as UNIX, LINUX, Microsoft Windows®, etc. More specifically, the instructions may cause various data manipulations on data stored in the memory device 210 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

In the example embodiment, the processor 208 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

The controller 108 includes circuitry 214 configured to communicate with the cardholder mobile computing device 106 (shown in FIG. 1). The circuitry 214 may include, for example, leads, connectors, NFC-enabled circuitry, Wi-Fi-enabled circuitry, and Bluetooth-enabled circuitry. The portable payment card receptacle 102 is configured to enclose and at least partially seal the circuitry 214, which is susceptible to degradation from the ambient environment. In one suitable embodiment, the circuitry 214 is hermetically sealed in the portable payment card receptacle 102. For example, the circuitry 214 may be completely and permanently encased within the portable payment card receptacle 102. In other words, the portable payment card receptacle 102 and the circuitry 214 are intended to remain as a single, inseparable unit throughout the life of the controller 108. It is understood that the portable payment card receptacle 102 may be formed separately from the circuitry 214 and that the circuitry 214 can be placed into and sealed within the portable payment card receptacle 102 in a separate operation. In another suitable embodiment, the circuitry 214 can be selectively, sealingly enclosed within the portable payment card receptacle 102, where the portable payment card receptacle 102 includes a body defining a circuit element (not shown), a closure element (e.g., a flap, door, lid, etc.) attached to the body.

The portable payment card receptacle 102 is fabricated from a suitably selected material that facilitates minimizing an effect the material has on wireless signals emitted by, for example, the Wi-Fi component 202, the Bluetooth component 204, and transceiver 212 passing through the receptacle material. For example, and without limitation, suitable materials from which the portable payment card receptacle 102 may be fabricated include leather, synthetic resin (e.g., polyester), and cotton. In other embodiments, the portable payment card receptacle 102 may be fabricated from any material that enables the controller 108 to function as described herein.

In one embodiment, the audio/tactile output device 206 is configured to output audio and/or tactile elements in a form perceptible to a cardholder. The audio/tactile output device 206 can generate the perceptible audio and/or tactile forms in response to a signal received from the processor 208, as is described herein. The audio/tactile output device 206 may include for example, and without limitation, a sound transducer such as an electromagnetic or piezoelectric element for generating an audible alert. In addition, the audio/tactile output device 206 may include a tactile transducer such as a linear or rotational vibrating device for generating a vibrational sensation, such as a pulse, plurality of pulses, and/or continuous vibration for a determined period.

In the exemplary embodiment, the transceiver 212 includes an antenna 216. The antenna 216 includes a looped wire configured to transmit radio waves or signals when current flows through the looped wire. The antenna 216 is any size, shape, and configuration that is suitable for transmitting signals as described herein. For example, the antenna 216 is a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 216 generates a magnetic field when it vibrates at a selected frequency. Specifically, the antenna 216 is configured to vibrate at a frequency of about 13.56 MHz, which is suitable for use in a near field communication (NFC) system.

In the example embodiment, the antenna 216 transmits radio signals to and receives radio signals from, for example, the payment card 104 (shown in FIG. 1), the cardholder mobile computing device 106, and/or any other components used in NFC systems. In NFC systems, at least one NFC component generates a magnetic field to inductively transfer currents and, thereby, exchange signals and information with other NFC components positioned within the magnetic field. In the exemplary embodiment, the antenna 216 functions as an NFC component to send and receive signals. The antenna 216 is configured to transmit radio signals to NFC components positioned within the magnetic field of the antenna 216, such as when the payment card 104 is stored or located within the portable payment card receptacle 102. Therefore, the magnetic field generated by the antenna 216 defines the active range of the controller 108. Additionally, the antenna 216 receives radio signals from NFC components when the antenna 216 is positioned within the magnetic field of the NFC components.

The transceiver 212 also includes a radio frequency (RF) interface 218 and an NFC device controller 220. The RF interface 218 and the NFC device controller 220 are powered by the power supply 210, as is the processor 208 and the memory device 210. The RF interface 218 is configured to receive and transmit RF signals through the antenna 216. The NFC device controller 220 is configured to process the received RF signals and to generate signals to be transmitted by the RF interface 218. The memory device 210 is configured to store data associated with transmitting and receiving the RF signals. The NFC device controller 220 is coupled in communication with the processor 208, which is configured to process and analyze the received RF signals.

In some embodiments, the controller 108 may be connected to one or more peripheral devices, such as one or more cardholder mobile computing devices 106. That is, the controller 108 may communicate various data with the cardholder mobile computing device 106. For example, the controller 108 may communicate with the cardholder mobile computing device 106 through the Wi-Fi component 202, the Bluetooth component 204, or other suitable means. When the controller 108 and the cardholder mobile computing device 106 communicate with each other through one of the wireless communication methods, a connection procedure necessary for a corresponding communication method may be performed. For example, and without limitation, when the controller 108 and the cardholder mobile computing device 106 attempt to communicate with each other through the Bluetooth component 204, a pairing procedure necessary for a Bluetooth communication method may be initiated by the controller 108.

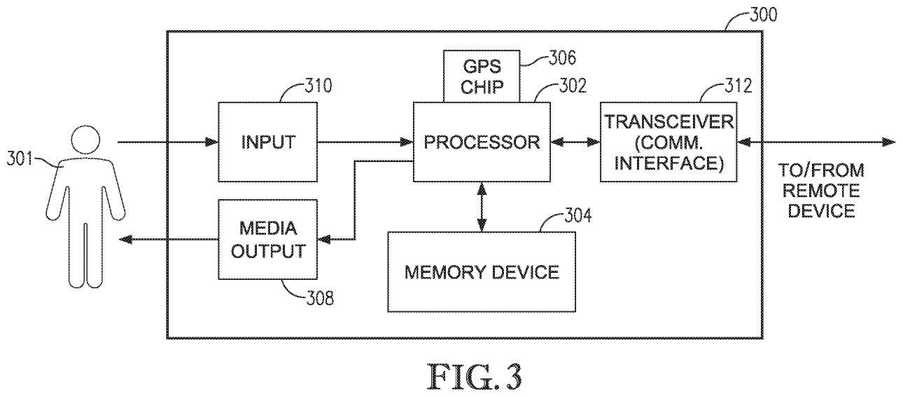

FIG. 3 is an example configuration of a user computing system, such as the cardholder mobile computing device 106, operated by a user, such as a cardholder 312. In the example embodiment, the cardholder mobile computing device 106 includes one or more processors 302 for executing instructions. In some embodiments, executable instructions are stored in a memory device 304. The processor 302 may include one or more processing units arranged, for example, in a multi-core configuration. The memory device 304 is any device allowing information such as executable instructions, written works, digital wallet data, etc. to be stored and retrieved. The memory device 304 includes one or more computer readable media.

A location of the cardholder mobile computing device 106 can be obtained through conventional methods, such as a location service (e.g., global positioning system (GPS) service) in the cardholder mobile computing device 106, “ping” data that includes geotemporal data, from cell location register information held by a telecommunications provider to which the cardholder mobile computing device 106 is connected, and the like. For example, in one suitable embodiment, a GPS chip 306 can be part of or separate from the processor 302 to enable the location of the cardholder mobile computing device 106 to be determined.

The cardholder mobile computing device 106 also includes at least one media output component 308 for presenting information to the cardholder 301. The media output component 308 is any component capable of conveying information to the cardholder 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the cardholder mobile computing device 106 includes an input device 310 for receiving input from the cardholder 301. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The cardholder mobile computing device 106 may also include a transceiver 312 (broadly, a communication interface), which is communicatively connectable to a remote device such as the portable payment card receptacle 102 (shown in FIGS. 1 and 2). The transceiver 312 may include, for example, a wired or wireless network adapter or a wireless data transceiver for use with radio frequency communication, Bluetooth, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the cardholder 301 via the media output component 308 and, optionally, receiving and processing input from the input device 310. A user interface may include, among other possibilities, a web browser and a payment card receptacle application 120 (broadly, a mobile App) (shown in FIG. 1). A web browser enables users, such as the cardholder 301, to display and interact with media and other information typically embedded on a web page or a website. The payment card receptacle application 120 allows the cardholder 301 to interact with the portable payment card receptacle 102 to facilitate keeping track of the one or more payment cards 104 (shown in FIG. 1).

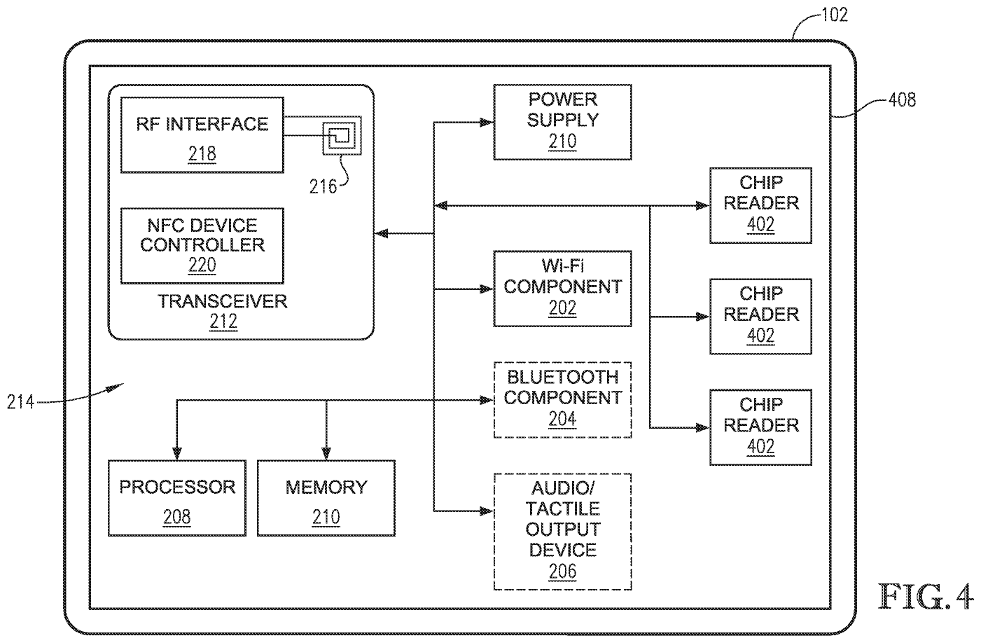

FIG. 4 is a schematic view of an alternative controller 408 that may be used in the portable payment card receptacle 102. In the example embodiment, the controller 408 is substantially similar to the controller 108 shown in FIG. 2. However, the controller 408 includes one or more chip readers 402. Each chip reader 402 includes a plurality of electrical contacts (not shown) configured to physically contact the electronic chip included on the payment cards 104, which allows the chip reader 402 to read and/or write to the electronic chip to facilitate the transmission of payment card data between the payment cards 104 and the controller 408. Each chip reader 402 may be embedded in the portable payment card receptacle 102, for example, in a card pocket, to facilitate physical contact with the payment card 104. The chip reader 402 may be coupled to the controller 408, for example, via a thin flexible cable or other flexible connection.

### Exemplary Method for Registering Payment Card

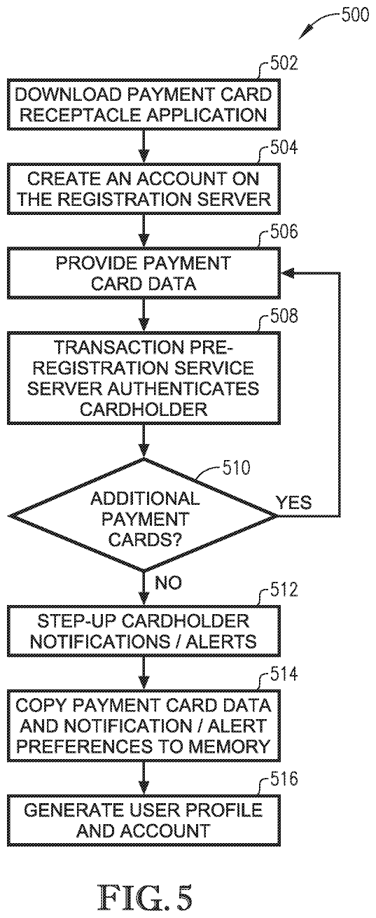

FIG. 5 is a flowchart illustrating an exemplary computer-implemented method 500 for registering one or more payment cards 104 (shown in FIG. 1) for use with the portable payment card receptacle 102 (shown in FIG. 1), in accordance with one embodiment of the present disclosure. The operations described herein may be performed in the order shown in FIG. 5 or may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1-4. In one embodiment, the method 500 may be implemented by the cardholder mobile computing device 106 and the payment card receptacle application 120 (each shown in FIG. 1). In the exemplary embodiment, the method 500 relates to the receiving of payment card registration information from the cardholder mobile computing device 106 upon registration for use with the portable payment card receptacle 102. While operations within the method 500 are described below regarding the cardholder mobile computing device 106, the method 500 may be implemented using the portable payment card receptacle 102 in conjunction with the cardholder mobile computing device 106 as well as other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

Referring to operation 502, in the example embodiment, the cardholder 301 (shown in FIG. 1) downloads the payment card receptacle application 120 (shown in FIG. 1). For example, the cardholder 301 may connect to a registration server, such as the registration server 122 (shown in FIG. 1) that is part of the interchange network 126 described above, which may instruct the cardholder 301 to download the payment card receptacle application 120 to the cardholder mobile computing device 106. Alternatively, the cardholder 301 may download the payment card receptacle application 120 from a mobile application web store that is compatible with the cardholder mobile computing device 106. When the cardholder 301 uses the payment card receptacle application 120, a direct link is established via a wireless connection, for example, via a Wi-Fi connection to the registration server 122 via the communications network 110 (shown in FIG. 1).

The cardholder mobile computing device 106, such as a web-based smartphone, is configured to execute for display the payment card receptacle application 120. In some embodiments, the payment card receptacle application 120 may be stored in a cloud-based interface, which may include cloud storage capability as well as any cloud-based API that facilitates communication between the cardholder mobile computing device 106 and the registration server 122. The payment card receptacle application 120 facilitates transmitting and receiving payment card data between the cardholder mobile computing device 106 and the registration server 122 for registering and cardholder's payment cards 104 with the portable payment card receptacle 102.

At operation 504, the cardholder 301 is presented an option to create an account, including a user profile and payment card data associated with the one or more payment cards 104. For example, the cardholder 301 registers the payment cards 104 via the cardholder mobile computing device 106 or via a suitable webpage associated with the registration server 122 using, for example, an Internet connected computing device. It should be understood that the cardholder 301 may register with the transaction pre-registration service in any of several ways, including utilizing the cardholder mobile computing device 106 or other Internet connected devices to access the registration server 122 via the Internet and providing the required information. During cardholder registration, the cardholder 301 may provide registration data including basic information about himself or herself (e.g., name, address, phone number, etc.) and, in some embodiments, provide information regarding the customer's mobile devices (for example, by providing a SIM identifier and/or a mobile telephone number and/or other device identifier). It is noted that the account can be linked to other Mastercard services if the cardholder 301 is already signed up for other unrelated services. In some embodiments, the information obtained from the cardholder 301 during the registration process includes product and/or service preferences, requirements data, and/or other information.

At operation 506, the cardholder 301 may also provide data concerning his or her payment card 104, e.g., bank credit card account, debit card account, loyalty card account, and/or gift card issued to or held by him or her. The payment card data may include, for example, a primary account number (PAN) and personal identification number (PIN) for each respective payment card 104. The payment card data may be provided, for example, via the cardholder mobile computing device 106 using the payment card receptacle application 120, or by establishing a connection between the payment card 104 and the portable payment card receptacle 102 (e.g., wirelessly or physically). When using the portable payment card receptacle 102, the payment card data may be read by the controller 108 or 408 and transferred to the payment card receptacle application 120 running on the cardholder mobile computing device 106. As described earlier, when the controller 108 and the cardholder mobile computing device 106 attempt to communicate with each other through the Bluetooth component 204, a pairing procedure necessary for the Bluetooth communication method may be initiated by the controller 108. The cardholder 301 may then choose to register the payment card using the transferred payment card data rather than inputting the data himself

At operation 508, the registration server 122 authenticates the cardholder 301. For example, and without limitation, the cardholder 301 may be asked to input a string of characters indicating a code printed on the signature panel of the cardholder's payment card 104. For example, the signature panel code may be a card verification code (CVC) value. The values entered by the cardholder 301 may be used by the registration server 122 to authenticate the cardholder 301 prior to registering the payment card 104 for use with the portable payment card receptacle 102 and associating the cardholder 301 and the cardholder's payment card 104 with the account. For example, the registration server 122 compares the entered values to the values associated with the payment card stored in a database (e.g., the database 134 shown in FIG. 1). If the entered values match the stored values, the cardholder 301 is authenticated.

Optionally, the method 500 may include an additional operation for authenticating the cardholder 301 offline. For example, and without limitation, the registration server 122 may provide an offline PIN to the cardholder 301 via mail, text, etc.

At operation 510, the registration server 122 asks the cardholder 301 whether the cardholder has additional payment cards 104 he or she wishes to associate with the cardholder's account. If the cardholder has additional payment cards to enter, the method 500 returns to operation 506 and receives the additional payment card details from the cardholder 301. If the cardholder does not have any additional payment cards to enter, the method continues to operation 512.

At operation 512, the registration server 122, or in some embodiments, the payment card receptacle application 120, requests that the cardholder 301 select one or more options for receiving notifications and/or alerts from the portable payment card receptacle 102 and/or the payment card receptacle application 120 installed on the cardholder mobile computing device 106. The alerts may include, for example, and without limitation, time limits that a registered payment card 104 is not in communication with the portable payment card receptacle 102, location related alerts, and the like. For example, a cardholder may set a time limit (e.g., three (3) minutes, five (5) minutes, etc.) for receiving an alert or notification after a payment card 104 is removed from and not returned to the portable payment card receptacle 102. The notification and/or alert may be set up as a recurring alert or a onetime alert, depending on the cardholder's preference. Furthermore, the notification and/or alert may include a location related alert. For example, when a payment card 104 is removed from the portable payment card receptacle 102, the portable payment card receptacle 102 may send a signal to the transaction pre-registration service application 140 installed on the cardholder mobile computing device 106 to temporarily record the physical location of the cardholder mobile computing device 106. If the location of the cardholder mobile computing device 106 changes more than a cardholder specified threshold distance before the payment card 104 is returned to the portable payment card receptacle 102, the transaction pre-registration service application 140 may generate an audio/visual alert on the cardholder mobile computing device 106 to indicate that the payment card 104 has not been returned.

At operation 514, the registered payment cards (i.e., the payment card data) and the options for receiving notifications and/or alerts are transferred or copied to the memory of the controller 108 or 408 of the portable payment card receptacle 102. At operation 516, the registration server 122 generates the account, including the user profile for the cardholder 301, associating the cardholder's one or more payment cards 104 with the account along with the cardholder's account access credentials.

### Exemplary Method for Monitoring Payment Card

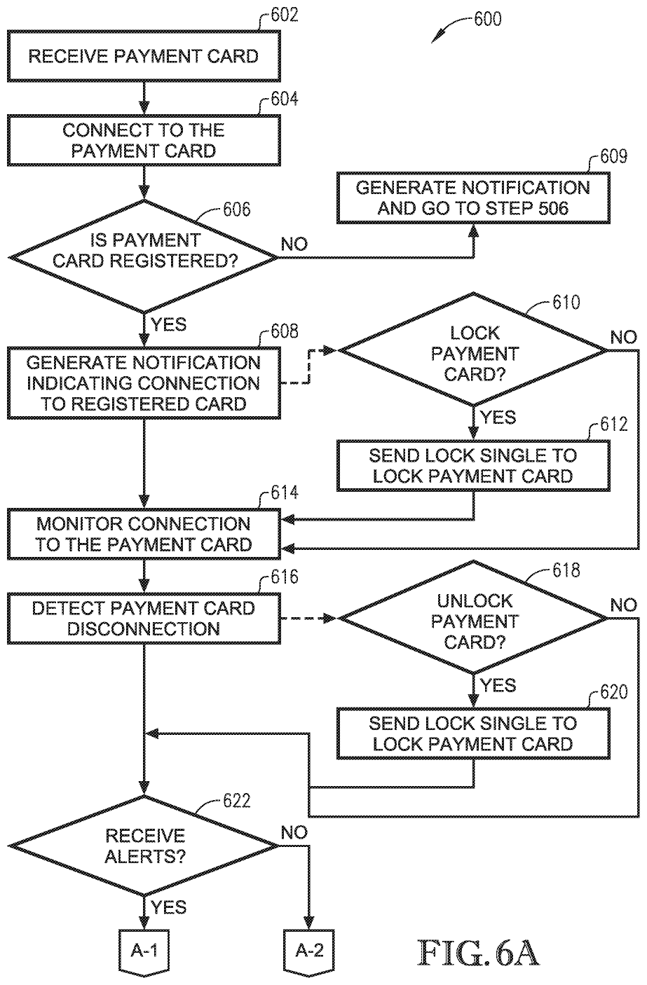

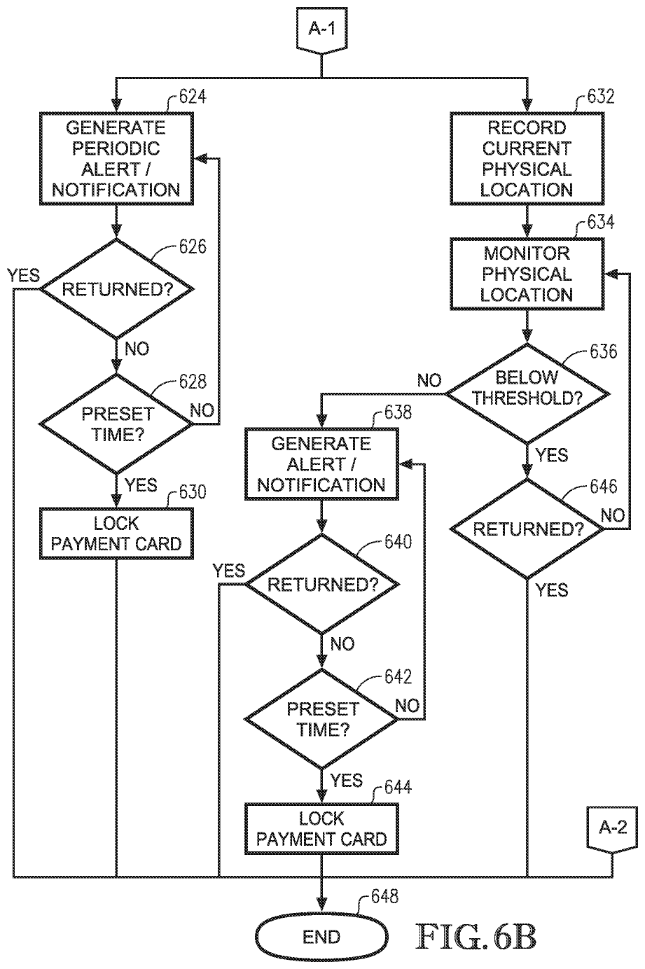

FIGS. 6A and 6B illustrate a flowchart depicting an exemplary computer-implemented method 600 for detecting and monitoring a payment card, such as the payment card 104, stored in the portable payment card receptacle 102 (shown in FIG. 1), in accordance with one embodiment of the present disclosure. The operations described herein may be performed in the order shown in FIG. 6 or may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1-4. In one embodiment, the method 600 may be implemented by the portable payment card receptacle 102. Alternatively, the method 600 may be partly implemented by the portable payment card receptacle 102 and partly by the cardholder mobile computing device 106 and the payment card receptacle application 120 (each shown in FIG. 1). In the exemplary embodiment, the method 600 relates to detecting and monitoring a payment card stored in the portable payment card receptacle 102 and alerting the cardholder when the payment card is removed from and/or has not been returned to the portable payment card receptacle 102. While operations within the method 600 are described below regarding the portable payment card receptacle 102, the method 600 may be implemented using the portable payment card receptacle 102 in conjunction with the cardholder mobile computing device 106 as well as other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

Referring to operation 602, in the example embodiment, the portable payment card receptacle 102 may receive therein a payment card, such as the payment card 104 (shown in FIG. 1), for temporary storage. For example, the portable payment card receptacle 102 may be in the form of a wallet in which the cardholder 301 wishes to carry his or her payment card 104 within when not in use.

When the payment card 104 is inserted into the portable payment card receptacle 102, at operation 604 the controller, such as the controller 108 or 408, electrically connects to or otherwise establishes communication with the payment card to scan and read the payment card data therefrom. For example, when the payment card 104 is placed within or positioned within a predetermined distance of the portable payment card receptacle 102, or more particularly, the controller 108, the controller sends an initial signal wirelessly over the wireless connection 112 to the electronic chip included on the payment card 104. That is, the controller 108, an active device, generates a local magnetic field which induces an electric current in the electronic chip of the payment card 104, a passive device. The electrical energy powers the electronic chip, which creates a further magnetic field in the electronic chip's antenna which can be read by controller, thus allowing the payment card data to be transferred. Alternatively, as described with respect to FIG. 4, the controller 408 physically connects to the payment card 104 and uses the chip reader 402 to directly read the payment card data therefrom.

At operation 606, controller 108 or 408 of the portable payment card receptacle 102 may determine if the payment card is a registered payment card. If the payment card 104 is a registered payment card (i.e., the data read from the payment card matches payment card data stored in memory), at operation 608 the controller may generate a notification indicating that the payment card is registered and that the controller has successfully connected to the payment card 104. For example, the controller may generate an audible or tactile alert using the audio/tactile output device 206 (shown in FIG. 2) and/or send a message to the payment card receptacle application 120 for display to the cardholder 301 via the cardholder mobile computing device 106.

If the payment card is not a registered payment card, at operation 609, the portable payment card receptacle 102 may generate a notification indicating the card is not registered. For example, the controller may generate an audible or tactile alert using the audio/tactile output device 206 (shown in FIG. 2) and/or send a message to the payment card receptacle application 120 for display to the cardholder 301 via the cardholder mobile computing device 106. A notification displayed on the cardholder mobile computing device 106 may request that the cardholder register the payment card for monitoring by the portable payment card receptacle 102, for example, where the method may return to operation 506 of the method 500 describe above.

In one suitable embodiment, the controller 108 or 408 may optionally lock the payment card 104 while it is contained in the portable payment card receptacle 102. For example, at operation 610, the controller 108 or 408 may send a message to the cardholder 301, for example via the payment card receptacle application 120 asking whether the cardholder would like to lock the payment card 104. If the cardholder 301 chooses to lock the payment card, at operation 612 the controller may send a lock signal to the electronic chip of the payment card 104 via connection 112, thereby locking the payment card 104 against use. In addition, the payment card receptacle application 120 may send a signal to the card issuer (not shown) locking the payment card 104 against use.

At operation 614, the controller 108 or 408 monitors the connection to the payment card 104 to verify that the payment card 104 is contained within the portable payment card receptacle 102. For example, the controller 108 or 408 may maintain a constant connection to the payment card 104. In some embodiments, to facilitate maintaining increased operational time (e.g., prolonging battery life, etc.), the controller 108 or 408 may periodically verify the connection to the payment card on a specified time interval, for example, multiple times per second, every second, multiples of seconds, minutes, etc. The time interval may be programmed into the controller 108 or 408 as a fixed time interval or may be a time interval specified by the cardholder 301, for example, by input via the payment card receptacle application 120.

At operation 616, the controller 108 or 408 detects that the payment card 104 is no longer connected to the portable payment card receptacle 102 (i.e., the controller 108 or 408). For example, if the cardholder 301 removes the payment card 104 from the portable payment card receptacle 102 to perform a transaction, the controller 108 or 408 will lose the connection 112. Upon loss of the connection 112 between the portable payment card receptacle 102 and the payment card 104, the controller initiates a notification/alert process.

In one suitable embodiment, the controller 108 or 408 may optionally unlock the payment card 104 while it is contained in the portable payment card receptacle 102. For example, at operation 618, the controller 108 or 408 may send a message to the cardholder 301, for example via the payment card receptacle application 120 asking whether the cardholder would like to unlock the payment card 104 for use. If the cardholder 301 chooses to unlock the payment card 104, at operation 620 the controller may send an unlock signal to the electronic chip of the payment card 104 via connection 112 (after establishing a connection to unlock the payment card), thereby unlocking the payment card 104 for use. In addition, the payment card receptacle application 120 may send a signal to the card issuer (not shown) unlocking the payment card 104 for use.

At operation 622, the controller 108 or 408 transmits a signal to the payment card receptacle application 120 for an alert/notification for display to the cardholder 301 indicating the payment card has been removed and requesting whether the cardholder chooses to receive further notifications/alerts until the payment card 104 is returned to the portable payment card receptacle 102. If the cardholder 301 chooses to continue receiving notifications/alerts, the method 600 continues at one or more of operations 624 and 626. If the cardholder 301 chooses not to receive any further alerts, the method 600 ends at operation 648.

At operation 624, the controller 108 or 408 may generate one or more alerts/notifications for display on the cardholder mobile computing device 106 via the payment card receptacle application 120, and/or alerts/notifications may be provided via the audio/tactile output device 206. The one or more alerts/notifications may indicate that the payment card 104 has not been returned to the portable payment card receptacle 102. The periodic alerts may be displayed and/or generated at a predetermined interval selected, for example, by the cardholder 301 or permanently set in the controller. The alerts/notifications may continue to be generated and/or displayed to the cardholder 301 until the payment card 104 is returned to the portable payment card receptacle 102 or until the cardholder selects to discontinue receiving the alerts via the payment card receptacle application 120.

At operation 626, the controller 108 or 408 determines whether the payment card 104 has been returned to the payment card receptacle 102 (i.e., whether the controller has re-established the connection 112 by sensing the presence of the payment card 104). If the payment card 104 has been returned, the method 600 ends at operation 648. If the payment card 104 has not been returned, at operation 628 the controller determines whether a preset time limit has passed since the payment card 104 was removed (i.e., lost connection) from the payment card receptacle 102. The preset time limit may be a cardholder selected time limit or may be an otherwise predefined time limit in the controller 108 or 408. If the preset time limit has not passed, the process continues with the periodic alerts/notifications at operation 624. If the preset time limit has passed, at operation 630 the controller 108 or 408 transmits a lock signal (via the payment card receptacle application 120) to the card issuer locking the payment card 104 against use.

Alternatively or simultaneously with operation 624, at operation 632 the controller 108 or 408 transmits a signal to the payment card receptacle application 120 to record the physical location of the cardholder mobile computing device 106 (based on the GPS location data of the cardholder mobile computing device 106 as indicated by the GPS chip 306). The payment card receptacle application 120 then monitors the actual location of the cardholder mobile computing device 106, as indicated at operation 634.

At operation 636, the payment card receptacle application 120 compares the recorded current physical location of the cardholder mobile computing device 106 and a current location of the cardholder mobile computing device 106 to determine whether a difference in the recorded current physical location of the cardholder mobile computing device 106 and a current location of the cardholder mobile computing device 106 is below a cardholder selected or otherwise predefined threshold distance. If the distance changes and exceeds the threshold distance, at operation 638 the payment card receptacle application 120 generates an alert for display to the cardholder via the cardholder mobile computing device 106 and/or transmits a signal to the portable payment card receptacle 102 to generate an audible or tactile alert via the audio/tactile output device 206.

At operation 640, the controller 108 or 408 determines whether the payment card 104 has been returned to the payment card receptacle 102 (i.e., whether the controller has re-established the connection 112). If the payment card 104 has been returned, the method 600 ends at operation 648. If the payment card 104 has not been returned, at operation 642 the controller determines whether the preset time limit has passed since the payment card 104 was removed (i.e., lost connection) from the payment card receptacle 102. If the preset time limit has not passed, the process continues with the location alerts/notifications at operation 638. If the preset time limit has passed, at operation 644 the controller 108 or 408 transmits a lock signal (via the payment card receptacle application 120) to the card issuer locking the payment card 104 against use.

Returning to operation 636, if the distance has not changed to exceed the threshold distance, at operation 646 the payment card receptacle application 120 determines whether the payment card 104 has been returned to the payment card receptacle 102 (i.e., whether the controller has re-established the connection 112). If the payment card 104 has been returned, the method 600 ends at operation 648. If the payment card 104 has not been returned, the process continues with the monitoring location operation 634.

### Additional Considerations

Any actions, functions, operations, and the like recited herein may be performed in the order shown in the figures and/or described above or may be performed in a different order. Furthermore, some operations may be performed concurrently as opposed to sequentially. Although the methods are described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, Wi-Fi, IEEE 802 including Ethernet, WiMAX, and/or others), including supporting various local area networks (LANs), personal area networks (PAN), or short-range communications protocols.

The term “communication component,” “communication interface,” and the like (such as transceiver), as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), non-volatile RAM (NVRAM) memory, and/or other hard drives, flash memory, MicroSD cards, and others. The above memory types are example only and are thus not limiting as to the types of memory usable for storage of a computer program.

Although the invention has been described with reference to the one or more embodiments illustrated in the figures, it is understood that equivalents may be employed, and substitutions made herein without departing from the scope of the invention as recited in the claims.

Having thus described one or more embodiments of the invention, what is claimed as new and desired to be protected by Letters Patent includes the following:

What is claimed is:

1. An intelligent payment card carrying system for monitoring the presence of a payment card, wherein the payment card includes a microchip, said system comprising:
a cardholder computing device including a first transceiver; and
a payment card receptacle for receiving the payment card therein, said payment card receptacle including a controller, wherein the controller comprises:
a wireless communication device; and
a second transceiver comprising NFC-enabled circuitry,
wherein said controller is configured to communicate wirelessly with said cardholder computing device via said wireless communication device, and with the payment card via said second transceiver to transfer payment card data.

2. The intelligent payment card carrying system in accordance with claim 1, further comprising:
a registration server for communication with said cardholder computing device; and
a database coupled to said registration server, said database configured to receive and store the payment card data.

3. The intelligent payment card carrying system in accordance with claim 1, said controller being configured to communicate wirelessly with the payment card via a near field communication (NFC) system.

4. The intelligent payment card carrying system in accordance with claim 1, said NFC-enabled circuitry comprising an NFC antenna, a radio frequency (RF) interface, and an NFC device controller.

5. The intelligent payment card carrying system in accordance with claim 4, said NFC antenna operating at a frequency of about 13.56 MHz.

6. The intelligent payment card carrying system in accordance with claim 1, said controller further comprising a chip reader device for reading the payment card data from the microchip of the payment card.

7. The intelligent payment card carrying system in accordance with claim 1, said controller further comprising an audio/tactile output device configured to generate one or more of an audible or tactile alert upon communication between said second transceiver and the payment card.

8. A method for detecting and monitoring the presence of a payment card in a payment card receptacle, said method comprising:
receiving the payment card in the payment card receptacle;
communicatively coupling to the payment card to read the payment card data therefrom;
determining whether the payment card is a registered payment card with the payment card receptacle;
if the payment card is a registered payment card, generating a first notification indicating that the payment card receptacle has successfully communicatively coupled to the registered payment card;
detecting that the payment card is no longer communicatively coupled to the payment card receptacle; and
generating a second notification indicating that the payment card is no longer communicatively coupled to the payment card receptacle.

9. The method in accordance with claim 8, wherein the second notification includes a request to a cardholder requesting whether the cardholder chooses to receive further notifications or alerts until the payment card is returned to the payment card receptacle.

10. The method in accordance with claim 8, further comprising monitoring the connection to the payment card to verify that the payment card is contained in the payment card receptacle.

11. The method in accordance with claim 8, further comprising generating a third notification indicating that the payment card is not a registered payment card based upon the determination that the payment card is not a registered payment card with the payment card receptacle.

12. The method in accordance with claim 8, further comprising:
transmitting a request to a cardholder to lock the payment card; and
if the cardholder chooses to lock the payment card, transmitting a first lock signal to the payment card to lock the payment card against use.

13. The method in accordance with claim 12, further comprising transmitting a second lock signal to a card issuer of the payment card requesting that the payment card be locked.

14. The method in accordance with claim 8, further comprising generating periodic alerts indicating that the payment card has not been returned to the payment card receptacle.

15. The method in accordance with claim 8, further comprising:
determining that the payment card has been returned to the payment card receptacle, comprising:
sensing the presence of the payment card; and
communicatively re-coupling to the payment card.

16. The method in accordance with claim 8, further comprising:
determining that the payment card has not been returned to the payment card receptacle;
determining whether a preset time limit has passed since detecting that the payment card is no longer connected to the payment card receptacle; and
if the preset time limit has passed, transmitting a signal to an issuer of the payment card requesting that the payment card be locked against use.

17. The method in accordance with claim 8, further comprising transmitting a location signal to a payment card receptacle application installed on a cardholder mobile computing device to record a first location of the cardholder mobile computing device.

18. The method in accordance with claim 17, further comprising:
comparing the recorded first location of the cardholder mobile computing device to a current second location of the cardholder mobile computing device; and
determining whether a difference in the recorded first location of the cardholder mobile computing device and the current second location of the cardholder mobile computing device is below a predefined threshold distance.

19. The method in accordance with claim 18, further comprising generating an alert if the difference in the recorded first location of the cardholder mobile computing device and the current second location of the cardholder mobile computing device exceeds the predefined threshold distance.

20. The method in accordance with claim 19, further comprising:
determining that the payment card has not been returned to the payment card receptacle;
determining whether a preset time limit has passed since detecting that the payment card is no longer connected to the payment card receptacle; and
if the preset time limit has passed, transmitting a signal to an issuer of the payment card requesting that the payment card be locked against use.
